(19) United States
(12) Patent Application Publication
(10) Pub. No.: US 2020/0257048 A1
(43) Pub. Date: Aug. 13, 2020

(54) MULTIPLEXING DEVICE OF TRANSMISSION LINE, AND ELECTRONIC DEVICE

(71) Applicant: SHENZHEN ROYOLE TECHNOLOGIES CO. LTD., Shenzhen (CN)

(72) Inventor: Bihua YANG, Shenzhen (CN)

(21) Appl. No.: 16/651,579

(22) PCT Filed: Oct. 19, 2017
(86) PCT No.: PCT/CN2017/106861

§ 371 Date: Mar. 27, 2020

(51) Int. Cl. G02B 6/293; H04J 14/02

(52) U.S. Cl. CPC G02B 6/2938; H04J 14/0209

(57) ABSTRACT

The present disclosure provides a multiplexing device of a transmission line, and an electronic device. The multiplexing device comprises a first switch unit, a second switch unit, and a control unit. The first switch unit is coupled between a first connection terminal of the transmission line and a first circuit, and the second switch unit is coupled between the first connection terminal and a second circuit. The control unit is configured to output a first control signal and a second control signal. The first control signal is configured to switch on the first switch unit and switch off the second switch unit, to make the first connection terminal be electrically coupled to the first circuit; the second control signal is configured to switch off the first switch unit and switch on the second switch unit, to make the first connection terminal be electrically coupled to the second circuit.

### CROSS-REFERENCE TO RELATED APPLICATION(S)

This present application is a National Phase of International Application No. PCT/CN2017/106861, filed on Oct. 19, 2017.

### TECHNICAL FIELD

The present disclosure relates to the field of electronic technology, and more particularly to a multiplexing device of a transmission line, and an electronic device having the multiplexing device of the transmission line.

### BACKGROUND

With development of electronic technology and mobile communication technology, small smart electronic devices such as mobile phones, tablet computers, laptops, etc. have been widely used. In order to meet design requirements of miniaturization of electronic devices, in the circuit design, a circuit that transmits one kind of signals is usually multiplexed into a circuit that transmits two or more kinds of signals, for example, a high-speed signal line is multiplexed into a power transmission line. A relay is usually used in existing practices to implement line multiplexing. However, there are some disadvantages in using the relay to realize line multiplexing. For example, the large volume of the relay cannot meet the volume requirements of small electronic devices for components. In addition, the high price of the relay is not conducive to reducing the manufacturing cost the products.

### SUMMARY

The present disclosure provides a multiplexing device of a transmission line, and an electronic device having the multiplexing device of the transmission line.

An aspect of the present disclosure provides a multiplexing device of a transmission line. The transmission line includes a first connection terminal and a second connection terminal opposite to each other. The multiplexing device of the transmission line at least includes a first switch unit coupled between the first connection terminal of the transmission line and a first circuit; a second switch unit coupled between the first connection terminal of the transmission line and a second circuit; and a control unit electrically coupled to the first switch unit and the second switch unit, respectively, where the control unit is configured to output a first control signal and a second control signal. The first control signal is configured to switch on the first switch unit, as well as switch off the second switch unit, to make the first connection terminal of the transmission line be electrically coupled to the first circuit. The second control signal is configured to switch off the first switch unit, as well as switch on the second switch unit, to make the first connection terminal of the transmission line be electrically coupled to the second circuit.

Another aspect of the present disclosure provides an electronic device which includes a transmission line, a multiplexing device of the transmission line, and a connection interface. The transmission line includes a first connection terminal and a second connection terminal opposite to each other. The connection interface includes a terminal to which the second connection terminal of the transmission line is electrically coupled.

The multiplexing device of the transmission line at least includes a first switch unit coupled between the first connection terminal of the transmission line and a first circuit; a second switch unit coupled between the first connection terminal of the transmission line and a second circuit; and a control unit electrically coupled to the first switch unit and the second switch unit, respectively, where the control unit is configured to output a first control signal and a second control signal. The first control signal is configured to switch on the first switch unit, as well as switch off the second switch unit, to make the first connection terminal of the transmission line be electrically coupled to the first circuit. The second control signal is configured to switch off the first switch unit, as well as switch on the second switch unit, to make the first connection terminal of the transmission line be electrically coupled to the second circuit.

### BRIEF DESCRIPTION OF THE DRAWINGS

To describe the technical solutions in the implementations of the present disclosure or related arts more clearly, the accompanying drawings required for describing the implementations or the prior arts are briefly introduced below. Obviously, the accompanying drawings described below are merely some implementations of the present disclosure. For those of ordinary skill in the art, other drawings can also be obtained based on these drawings without paying creative work.

FIG. 1 is a functional block diagram of a multiplexing device of a transmission line according to an implementation of the present disclosure.

FIG. 2 is a schematic diagram of a specific circuit structure of the multiplexing device of FIG. 1 according to an implementation of the present disclosure.

FIG. 3 is a schematic diagram of a specific circuit structure of an electronic device according to an implementation of the present disclosure.

FIG. 4 is a schematic diagram of a specific circuit structure of an electronic device according to other implementation of the present disclosure.

### DESCRIPTION OF REFERENCE NUMBERS OF MAIN COMPONENT

Multiplexing device of transmission line: 20; first switch unit: 21, Q1; first control terminal: 211; first conductive terminal: 212; second conductive terminal: 213; second switch unit: 22, Q2; second control terminal: 221; third conductive terminal: 222; fourth conductive terminal: 223; control unit: 23, U1; first control signal output terminal: CTR1; second control signal output terminal: CTR2; conduction suppression circuit: 24; magnetic bead: L1; capacitor: C1; transmission line: 30, D-; first connection terminal: 31; second connection terminal: 32; first circuit: 41; voltage output terminal: VCC; second circuit: 42; electronic device: 100, 101, 102; connection interface: CON, CON1, CON2; charge circuit: U5; battery: U6.

The present disclosure will be further described in the following specific implementations in combination with the above accompanying drawings.

### DETAILED DESCRIPTION OF ILLUSTRATED IMPLEMENTATIONS

The technical solutions in the implementations of the present disclosure will be described clearly and completely below with reference to the accompanying drawings in the implementations of the present disclosure. Obviously, the described implementations are merely a part of the implementations of the present disclosure, but not all of the implementations. Based on the implementations of the present disclosure, all other implementations obtained by those of ordinary skill in the art without any creative efforts shall fall within the protection scope of the present disclosure.

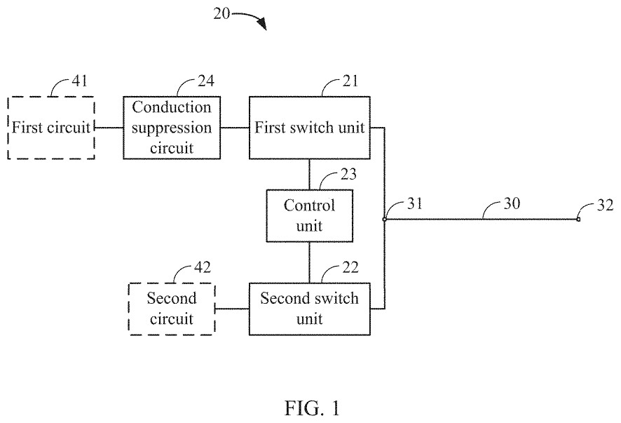

FIG. 1 is a functional block diagram of a multiplexing device 20 of a transmission line 30 according to an implementation of the present disclosure. In the implementation, the multiplexing device 20 of the transmission line 30 at least includes a first switch unit 21, a second switch unit 22, and a control unit 23. The transmission line 30 includes a first connection terminal 31 and a second connection terminal 32 opposite to each other. The first switch unit 21 is coupled between the first connection terminal 31 of the transmission line 30 and a first circuit 41. The second switch unit 22 is coupled between the first connection terminal 31 of the transmission line 30 and a second circuit 42.

The control unit 23 is electrically coupled to the first switch unit 21 and the second switch unit 22, respectively. The control unit 23 is configured to output a first control signal and a second control signal. The first control signal is configured to switch on the first switch unit 21, as well as switch off the second switch unit 22, to make the first connection terminal 31 of the transmission line 30 be electrically coupled to the first circuit 41. The second control signal is configured to switch off the first switch unit 21, as well as switch on the second switch unit 22, to make the first connection terminal 31 of the transmission line 30 be electrically coupled to the second circuit 42.

In the implementation, the first circuit 41 is a direct-current (DC) power source network. When the first switch unit 21 is switched on to make the first connection terminal 31 of the transmission line 30 be electrically coupled to the first circuit 41, the transmission line 30 is able to transmit power signals. The second circuit 42 is a high-speed signal network. When the second switch unit 22 is switched on to make the first connection terminal 31 of the transmission line 30 be electrically coupled to the second circuit 42, the transmission line 30 is able to transmit high-speed signals. That is, the multiplexing device 20 of the transmission line is able to multiplex a high-speed signal line into a power transmission line.

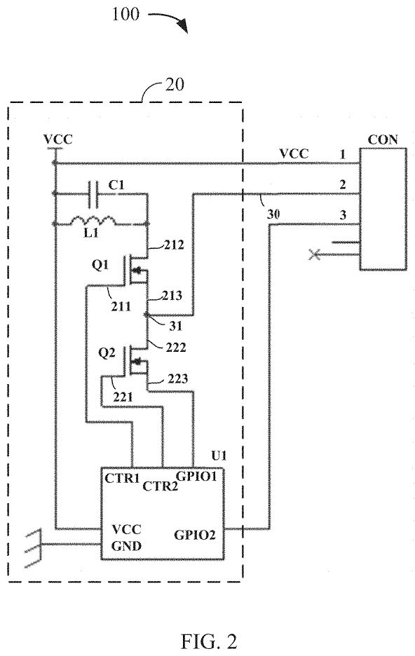

FIG. 2 is a schematic diagram of a specific circuit structure of the multiplexing device 20 of the transmission line according to an implementation. In the implementation, the multiplexing device 20 of the transmission line at least includes a first switch unit Q1, a second switch unit Q2, and a control unit U1.

Specifically, the first switch unit Q1 includes a first control terminal 211, a first conductive terminal 212, and a second conductive terminal 213. The first conductive terminal 212 is electrically coupled to a voltage output terminal VCC of the first circuit 41. The second conductive terminal 213 is electrically coupled to the first connection terminal 31 of the transmission line 30.

The second switch unit Q2 includes a second control terminal 221, a third conductive terminal 222, and a fourth conductive terminal 223. The third conductive terminal 222 is electrically coupled to the first connection terminal 31 of the transmission line 30. The fourth conductive terminal 223 is electrically coupled to the second circuit 42.

In the implementation, for example, the first switch unit Q1 is an NMOS transistor. The first control terminal 211, the first conductive terminal 212, and the second conductive terminal 213 correspond to the gate, the drain, and the source of the NMOS transistor, respectively. It can be understood that, in other implementations, the first switch unit 21 may be implemented by a PMOS transistor, an NPN transistor, or a PNP transistor.

In the implementation, for example, the second switch unit Q2 is an NMOS transistor. The second control terminal 221, the third conductive terminal 222, and the fourth conductive terminal 223 correspond to the gate, the drain, and the source of the NMOS transistor, respectively. It can be understood that, in other implementations, the second switch unit 22 may be implemented by a PMOS transistor, an NPN transistor, or a PNP transistor.

In the implementation, the first switch unit Q1 and the second switch unit Q2 are both a high-level on switch. In the implementation, the control unit U1 includes a first control signal output terminal CTR1 and a second control signal output terminal CTR2. The first control signal output terminal CTR1 is electrically coupled to the first control terminal 211 of the first switch unit Q1. The second control signal output terminal CTR2 is electrically coupled to the second control terminal 221 of the second switch unit Q2.

In the implementation, the control unit U1 is a micro controller unit (MCU). In the implementation, a pin GPIO1 of the MCU serves as a connection interface between the second switch unit Q2 and the second circuit 42.

The first control signal includes a set of level signals: a first high-level signal and a first low-level signal. The first control signal output terminal CTR1 is configured to output the first high-level signal to switch on the first switch unit Q1, and the second control signal output terminal CTR2 is configured to output the first low-level signal to switch off the second switch unit Q2, so that the first connection terminal 31 of the transmission lines 30 is electrically coupled to the first circuit 41.

The second control signal includes a set of level signals: a second low-level signal and a second high-level signal. The first control signal output terminal CTR1 is configured to output the second low-level signal to switch off the first switch unit Q1, and the second control signal output terminal CTR2 is configured to output the second high-level signal to switch on the second switch unit Q2, so that the first connection terminal 31 of the transmission lines 30 is electrically coupled to the second circuit 42.

It can be understood that, in other implementations, both of the first switch unit 21 and the second switch unit 22 may be a low-level on switch.

In other implementation, one of the first switch unit Q1 and the second switch unit Q2 is a high-level on switch, and the other is a low-level on switch. For example, one of the first switch unit Q1 and the second switch unit Q2 is an NMOS transistor, and the other is a PMOS transistor. Alternatively, one of the first switch unit Q1 and the second switch unit Q2 is an NPN transistor, and the other is a PNP transistor.

It can be understood that, in the other implementation, the control unit U1 may include a first control signal output terminal CTR1 and a second control signal output terminal CTR2. The first control signal output terminal CTR1 is electrically coupled to the first control terminal 211 of the switch unit Q1, and the second control signal output terminal CTR2 is electrically coupled to the second control terminal 221 of the second switch unit Q2.

It can be understood that, in the other implementation, the control unit 23 may include only one control signal output terminal, and the control signal output terminal is electrically coupled to the first control terminal 211 of the first switch unit Q1 and the second control terminal 221 of the second switch unit Q2, respectively. The control signal output terminal is configured to output the first control signal to switch on the first switch unit Q1, as well as switch off the second switch unit Q2, so that the first connection terminal 31 of the transmission line 30 is electrically coupled to the first circuit 41. The control signal output terminal is also configured to output the second control signal to switch off the first switch unit Q1, as well as switch on the second switch unit Q2, so that the first connection terminal 31 of the transmission line 30 is electrically coupled to the second circuit 42.

In use, when a high-speed signal needs to be transmitted, as described above, the pin CTR1 of the MCU outputs the second low-level signal to switch off the first switch unit Q1, and the pin CTR2 of the MCU outputs the second high-level signal to switch on the second switch unit Q2. At this time, the transmission line 30 is electrically coupled to the second circuit 42 through the pin GPIO1 of the MCU.

In the implementation, since the first switch unit 21 is a MOS transistor, there is a parasitic capacitance Cds (generally, the value of the parasitic capacitance Cds is tens of pF to hundreds of pF) on the MOS transistor, and a capacitor has characteristics of “blocking DC, passing AC; blocking low frequency, and passing high frequency” in the circuit, so the parasitic capacitance Cds on the MOS transistor will bring interference to the high-speed signal on the transmission line 30, resulting in the abnormal transmission of the high-speed signals on the transmission line 30.

In order to eliminate the influence of the parasitic capacitance Cds on the MOS transistor on the high-speed signal transmission, in the implementation, referring to FIG. 1 again, the multiplexing device 20 of the transmission line further includes a conduction suppression circuit 24 electrically coupled between the first circuit 41 and the first switch unit 21. The conduction suppression circuit 24 is configured to filter out high-frequency harmonics.

Referring to FIG. 2 again, in the implementation, the conduction suppression circuit 24 includes a magnetic bead L1. Specification of the magnetic bead L1 is 100Ω/100 MHZ, and DC impedance of the magnetic bead L1 is milliohm level. That is, the multiplexing device 20 of the transmission line of the present disclosure adds the magnetic bead L1 between the voltage output terminal VCC of the first circuit 41 and the first switch unit Q1. Since the magnetic bead L1 has a greater blocking effect on high-frequency signals, it is generally dedicated to suppress high-frequency noise and spike interference on signal lines and power lines, and also has the ability to absorb electrostatic pulses. When the frequency of the high-speed signal passing through the magnetic bead L1 is 100 MHz or more, the magnetic bead L1 may be equivalent to a resistor having a resistance value of 100Ω to hundreds of ohms. The equivalent resistor can greatly reduce the current flowing in and out of the parasitic capacitance Cds of the MOS transistor Q1 when the level of the high-speed signal changes, so that the high-speed signal can be normally transmitted on the transmission line 30.

In addition, when the frequency of the high-speed signal reaches GHz, the magnetic bead L1 can be equivalent to a capacitor having a capacitance value of pF-level. At this time, the equivalent capacitor is connected in series with the parasitic capacitance Cds on the MOS transistor, thereby greatly reducing the parasitic capacitance between the first circuit 41 and the second circuit 42, so that the high-speed signal can be normally transmitted on the transmission line 30.

Further, in order to transmit the high-speed signal more stably, the conduction suppression circuit 24 of the present disclosure further includes a capacitor C1 connected in parallel with the magnetic bead L1. In the implementation, the capacitor C1 is a pF capacitor. The magnetic bead L1 is connected in parallel with the capacitor C1, which can be equivalent to a series connection of a resistor Rx and a capacitor Cx. The equivalent capacitor Cx is connected in series with the parasitic capacitance Cds of the MOS transistor, which can also greatly reduce the parasitic capacitance between a circuit 41 and the second circuit 42, so that the high-speed signal can be normally transmitted on the transmission line 30.

When a power signal needs to be transmitted, as described above, the pin CTR1 of the MCU outputs a first high-level signal to switch on the first switch unit Q1, and the pin CTR2 of the MCU outputs the first low-level signal to switch off the second switch unit Q2. At this time, the transmission line 30 is electrically coupled to the voltage output terminal VCC of the first circuit 41 through the magnetic bead L1. In the implementation, since the first circuit 41 is a DC power source network that outputs a DC level signal, the DC impedance of the magnetic bead L1 is milliohm level, and the first switch unit Q1 is a MOS transistor whose conduction resistance Rds(on) is also milliohm level, those structures are equivalent to that the transmission line 30 is directly short circuited with the first circuit 41, so that the transmission line 30 can be configured to transmit a power signal. That is, the existence of the conduction suppression circuit 24 will not bring influence to the power signal transmission.

By means of the multiplexing device 20 of the transmission line of the present disclosure, the transmission line can be multiplexed into a line capable of transmitting two or more kinds of signals by replacing a relay with the switch units thereby reducing manufacturing cost of products. Meanwhile, the volumes of the switch units are small, which can meet the volume requirements of small electronic devices for components.

Referring to FIG. 2 again, an implementation of the present disclosure further provides an electronic device 100, which at least includes the transmission line 30, the multiplexing device 20 of the transmission line, and a connection interface CON. The connection interface CON includes a terminal, such as a terminal 2 that is electrically coupled with the second connection terminal 32 of the transmission line 30.

In the implementation, the connection interface CON may be a USB interface. In other implementations, the connection interface CON may also be an HDMI micro interface or other types of interfaces.

The electronic device 100 may be a mobile electronic product, and may be implemented as a first electronic device 101 (such as a power adapter), or a second electronic device 102 (such as a smart phone, a tablet computer, or a laptop), which will be described below.

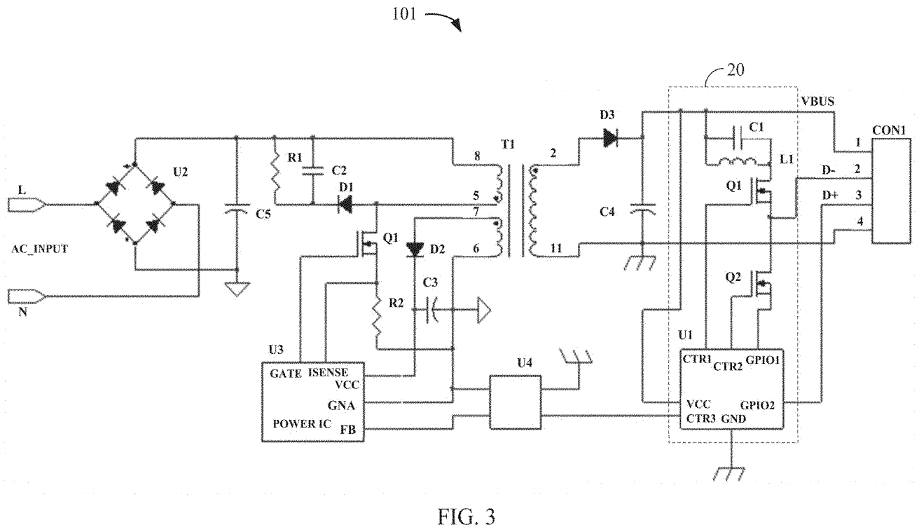

FIG. 3 is a schematic diagram of a specific circuit structure of the first electronic device 101 according to an implementation of the present disclosure. In the implementation, the electronic device 101 is a power adapter, and the multiplexing device 20 of the transmission line is applied to the power adapter to implement a fast charging function as well as a data transmitting function.

Specifically, the electronic device 101 at least includes a transmission line D-, the multiplexing device 20 of the transmission line, and a connection interface CON1. In the implementation, the multiplexing device 20 of the transmission line includes the first switch unit Q1, the second switch unit Q2, the control unit U1, the magnetic bead L1, the capacitor C1. The control unit U1 is an MCU.

When the transmission line D- is used for USB data signal transmission, as described above, the first switch unit Q1 is switched off and the second switch unit Q2 is switched on, thus making one end of the transmission line D- be coupled to the pin GPIO1 of the MCU, so that the transmission line D- is able to transmit USB data signals normally.

When the transmission line D- is used for power transmission, as described above, the first switch unit Q1 is switched on and the second switch unit Q2 is switched off, thus making the transmission line D- be short circuited with a VBUS network, so that the transmission line D- can be used for power transmission to realize the fast charging function.

Since the circuit structure of other parts of the electronic device 101 illustrated in FIG. 3 is not the focus of the present disclosure, it will not be described in detail here.

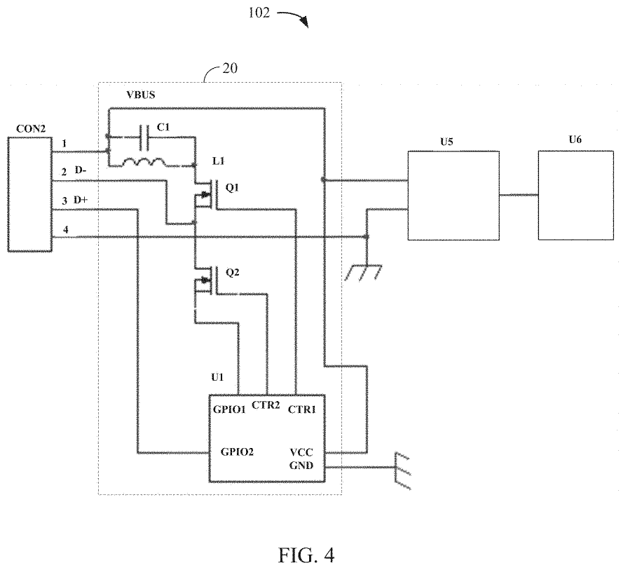

FIG. 4 is a schematic diagram of a specific circuit structure of the second electronic device 102 according to an implementation of the present disclosure. In the implementation, the electronic device 102 may be a mobile electronic product such as a smart phone, a tablet computer, or a laptop. The multiplexing device 20 of the transmission line is applied to the electronic device 102, and is able to implement the function of fast charging a battery of the electronic device 102, as well as a data transmitting function.

Specifically, the electronic device 102 at least includes a transmission line D-, the multiplexing device 20 of the transmission line, and a connection interface CON2. In the implementation, the multiplexing device 20 of the transmission line includes the first switch unit Q1, the second Switch unit Q2, the control unit U1, the magnetic bead L1, the capacitor C1. The control unit U1 is an MCU.

When the transmission line D- is used for USB data signal transmission, as described above, the first switch unit Q1 is switched off and the second switch unit Q2 is switched on, thus making one end of the transmission line D- be coupled to the pin GPIO1 of the MCU, so that the transmission line D- is able to transmit USB data signals normally.

When the transmission line D- is used for power transmission, as described above, the first switch unit Q1 is switched on and the second switch unit Q2 is switched off, thus making the transmission line D- be short circuited with a VBUS network, so that the transmission line D- can be used for power transmission, that is, a battery U6 is quickly charged through the charging circuit U5 of the electronic device 102.

Since the circuit structure of other parts of the electronic device 102 illustrated in FIG. 4 is not the focus of the present disclosure, it will not be described in detail here.

It can be understood that, in actual use, the connection interface CON1 of the electronic device 101 illustrated in FIG. 3 and the connection interface CON2 of the electronic device 102 illustrated in FIG. 4 can be connected together. Then, by connecting the electronic device 101 illustrated in FIG. 3 to a power source, the battery U6 of the electronic device 102 illustrated in FIG. 4 can be charged. Alternatively, by connecting the electronic device 101 illustrated in FIG. 3 to an external device, the electronic device 102 illustrated in FIG. 4 is able to implement data transmission with the external device.

For those skilled in the art, it is clear that the present disclosure is not limited to the details of the above exemplary implementations, and can be implemented in other specific forms without departing from the spirit or basic features of the present disclosure. Therefore, no matter from which point of view, the implementations should be regarded as exemplary and non-limiting. The scope of the present disclosure is defined by the appended claims rather than the above description. Therefore, it is intended to include all changes falling within the meaning and scope of equivalents of the claims in the disclosure. Any reference signs in the claims should not be construed as limiting the claims involved. In addition, it is clear that the word “comprising” does not exclude other units or steps, and the singular does not exclude the plural.

Finally, it should be noted that the above implementations are only used to illustrate the technical solutions of the present disclosure, not the limitation. Although the present disclosure has been described in detail with reference to the above preferred implementations, those skilled in the art should understand that the modifications or equivalent replacements of the solutions of the present disclosure should not depart from the spirit and scope of the technical solutions of the present disclosure.

1. A multiplexing device of a transmission line, the transmission line comprising a first connection terminal and a second connection terminal opposite to each other, the multiplexing device of the transmission line at least comprising:
a first switch unit coupled between the first connection terminal of the transmission line and a first circuit;
a second switch unit coupled between the first connection terminal of the transmission line and a second circuit; and
a control unit electrically coupled to the first switch unit and the second switch unit, respectively, wherein the control unit is configured to output a first control signal and a second control signal, wherein the first control signal is configured to switch on the first switch unit, as well as switch off the second switch unit, to make the first connection terminal of the transmission line be electrically coupled to the first circuit; the second control signal is configured to switch off the first switch unit, as well as switch on the second switch unit, to make the first connection terminal of the transmission line be electrically coupled to the second circuit.

2. The multiplexing device of the transmission line of claim 1, wherein the first circuit is a direct-current (DC) power source network; wherein the transmission line is able to transmit power signals, when the first switch unit is switched on to make the first connection terminal of the transmission line be electrically coupled to the first circuit;
wherein the second circuit is a high-speed signal network; wherein the transmission line is able to transmit high-speed signals, when the second switch unit is switched on to make the first connection terminal of the transmission line be electrically coupled to the second circuit.

3. The multiplexing device of the transmission line of claim 2, wherein the multiplexing device of the transmission line further comprises a conduction suppression circuit electrically coupled between the first circuit and the first switch unit, wherein the conduction suppression circuit is configured to filter high-frequency harmonics.

4. The multiplexing device of the transmission line of claim 3, wherein the conduction suppression circuit comprises a magnetic bead, wherein specification of the magnetic bead is 100Ω/100 MHZ, and DC impedance of the magnetic bead is in milliohm level.

5. The multiplexing device of the transmission line of claim 4, wherein the conduction suppression circuit further comprises a capacitor connected in parallel with the magnetic bead.

6. The multiplexing device of the transmission line of claim 3, wherein the first switch unit comprises a first conductive terminal and a second conductive terminal, wherein the first conductive terminal is electrically coupled to the first circuit, and the second conductive terminal is electrically coupled to the first connection terminal of the transmission line;
wherein the second switch unit comprises a third conductive terminal and a fourth conductive terminal, wherein the third conductive terminal is electrically coupled to the first connection terminal of the transmission line, and the fourth conductive terminal is electrically coupled to the second circuit.

7. The multiplexing device of the transmission line of claim 6, wherein the first switch unit and the second switch unit are both a high-level on switch or a low-level on switch;
the first switch unit further comprises a first control terminal, and the second switch unit further comprises a second control terminal;
the control unit comprises a first control signal output terminal and a second control signal output terminal, wherein the first control signal output terminal is electrically coupled to the first control terminal of the first switch unit, and the second control signal output terminal is electrically coupled to the second control terminal of the second switch unit.

8. The multiplexing device of the transmission line of claim 7, wherein the first switch unit and the second switch unit are both an NMOS transistor or a PMOS transistor; or
the first switch unit and the first switch unit are both an NPN transistor or a PNP transistor.

9. The multiplexing device of the transmission line of claim 6, wherein one of the first switch unit and the second switch unit is a high-level on switch, and the other is a low-level on switch;
the first switch unit further comprises a first control terminal, and the second switch unit further comprises a second control terminal;
the control unit comprises a control signal output terminal electrically coupled to the first control terminal of the first switch unit and the second control terminal of the second switch unit, respectively; or
the control unit comprises a first control signal output terminal and a second control signal output terminal, wherein the first control signal output terminal is electrically coupled to the first control terminal of the first switch unit, and the second control signal output terminal is electrically coupled to the second control terminal of the second switch unit.

10. The multiplexing device of the transmission line of claim 9, wherein one of the first switch unit and the second switch unit is an NMOS transistor, and the other is a PMOS transistor; or
one of the first switch unit and the second switch unit is an NPN transistor, and the other is a PNP transistor.

11. An electronic device comprising a transmission line, a multiplexing device of the transmission line, and a connection interface; the transmission line comprising a first connection terminal and a second connection terminal opposite to each other; the connection interface comprising a terminal to which the second connection terminal of the transmission line is electrically coupled; the multiplexing device of the transmission line at least comprising:
a first switch unit coupled between the first connection terminal of the transmission line and a first circuit;
a second switch unit coupled between the first connection terminal of the transmission line and a second circuit; and
a control unit electrically coupled to the first switch unit and the second switch unit, respectively, wherein the control unit is configured to output a first control signal and a second control signal, wherein the first control signal is configured to switch on the first switch unit, as well as switch off the second switch unit, to make the first connection terminal of the transmission line be electrically coupled to the first circuit; the second control signal is configured to switch off the first switch unit, as well as switch on the second switch unit, to make the first connection terminal of the transmission line be electrically coupled to the second circuit.

12. The electronic device of claim 11, wherein the first circuit is a DC power source network; wherein the transmission line is able to transmit power signals, when the first switch unit is switched on to make the first connection terminal of the transmission line be electrically coupled to the first circuit;
wherein the second circuit is a high-speed signal network; wherein the transmission line is able to transmit high-speed signals, when the second switch unit is switched on to make the first connection terminal of the transmission line be electrically coupled to the second circuit.

13. The electronic device of claim 12, wherein the electronic device further comprises a conduction suppression circuit electrically coupled between the first circuit and the first switch unit, wherein the conduction suppression circuit is configured to filter high-frequency harmonics.

14. The electronic device of claim 13, wherein the conduction suppression circuit comprises a magnetic bead, wherein specification of the magnetic bead is 10052/100 MHZ, and DC impedance of the magnetic bead is in milliohm level.

15. The electronic device of claim 14, wherein the conduction suppression circuit further comprises a capacitor connected in parallel with the magnetic bead.

16. The electronic device of claim 13, wherein the first switch unit comprises a first conductive terminal and a second conductive terminal, wherein the first conductive terminal is electrically coupled to the first circuit, and the second conductive terminal is electrically coupled to the first connection terminal of the transmission line;
wherein the second switch unit comprises a third conductive terminal and a fourth conductive terminal, wherein the third conductive terminal is electrically coupled to the first connection terminal of the transmission line, and the fourth conductive terminal is electrically coupled to the second circuit.

17. The electronic device of claim 16, wherein the first switch unit and the second switch unit are both a high-level on switch or a low-level on switch;
the first switch unit further comprises a first control terminal, and the second switch unit further comprises a second control terminal;
the control unit comprises a first control signal output terminal and a second control signal output terminal, wherein the first control signal output terminal is electrically coupled to the first control terminal of the first switch unit, and the second control signal output terminal is electrically coupled to the second control terminal of the second switch unit.

18. The electronic device of claim 17, wherein the first switch unit and the second switch unit are both an NMOS transistor or a PMOS transistor; or
the first switch unit and the first switch unit are both an NPN transistor or a PNP transistor.

19. The electronic device of claim 16, wherein one of the first switch unit and the second switch unit is a high-level on switch, and the other is a low-level on switch;
the first switch unit further comprises a first control terminal, and the second switch unit further comprises a second control terminal;
the control unit comprises a control signal output terminal electrically coupled to the first control terminal of the first switch unit and the second control terminal of the second switch unit, respectively; or
the control unit comprises a first control signal output terminal and a second control signal output terminal, wherein the first control signal output terminal is electrically coupled to the first control terminal of the first switch unit, and the second control signal output terminal is electrically coupled to the second control terminal of the second switch unit.

20. The electronic device of claim 16, wherein the electronic device is selected from a group consisting of a power adapter, a smart phone, a tablet computer, and a laptop.
